(19) United States
(12) Patent Application Publication
(10) Pub. No.: US 2025/0279532 A1
(43) Pub. Date: Sep. 4, 2025

(54) Battery Cell with Venting Cover and Battery Module Including the Same

(71) Applicant: SK On Co., Ltd., Seoul (KR)

(72) Inventors: Byeong Jun PAK, Daejeon (KR); Soo Min PARK, Daejeon (KR)

(21) Appl. No.: 18/985,632

(22) Filed: Dec. 18, 2024

(30) Foreign Application Priority Data
Feb. 29, 2024 (KR) 10-2024-0030275

(51) Int. Cl. H01M 50/342; H01M 50/147

(52) U.S. Cl. CPC H01M 50/3425; H01M 50/147; H01M 2200/20

(57) ABSTRACT

A battery cell includes: a case accommodating an electrode assembly in an accommodating space; a cap plate coupled to at least one side of the case; a vent provided in the case or the cap plate; and a venting cover disposed to cover the vent, and provided to be opened by pressure acting from the accommodating space to the outside of the case, wherein the venting cover includes a venting sheet provided to be opened by a predetermined amount of pressure, and including a first surface facing the vent and a second surface opposite to the first surface; and a venting cap having a support portion supporting the first surface of the venting sheet.

### CROSS-REFERENCE TO RELATED APPLICATION(S)

This patent document claims the priority and benefits of Korean Patent Application No. 10-2024-0030275 filed on Feb. 29, 2024, the disclosure of which is incorporated herein by reference in its entirety.

### TECHNICAL FIELD

The present disclosure relates to a battery cell having a venting cover and a battery module including the same.

### BACKGROUND

A secondary battery, unlike a primary battery, has convenience, in that it can be charged and discharged, and is attracting a lot of attention as a power source for various mobile devices and electric vehicles.

Such a secondary battery may include a battery cell in which an electrode assembly formed by stacking a cathode plate, an anode plate, and a separator or by winding the same in a roll shape is accommodated inside a case together with an electrolyte. A plurality of battery cells may be stacked in a predetermined direction and accommodated in a battery module or battery pack.

Some types of secondary batteries may include a vent connecting the inside of the case and the outside of the case for communication therebetween to allow gas generated inside the case to be released to the outside of the case when an event such as thermal runaway has occurred. However, there may be a problem that flames or gas flowing from the exterior of the case through the vent can also flow into the interior of the case.

The above description is provided to help understand the technical background of the present disclosure, and should not be construed as reducing, limiting, or restricting the technical idea of the present disclosure. In addition, the contents described or suggested in the above description do not necessarily refer to prior art, and some may include contents that do not fall under prior art.

### SUMMARY

An aspect of the present disclosure may provide a battery cell that can discharge flames, gas, or the like, within an accommodating space to the outside of a case when an event has occurred, but can prevent flames, gas, or the like from the outside of the case, from flowing into the accommodating space.

An aspect of the present disclosure may provide a battery module that can discharge flames, gas, or the like, within the accommodating space to the outside of a case when an event has occurred, but can prevent flames or gas, generated within an adjacent battery cell from flowing thereinto.

In addition, a battery cell and a battery module including the same of the present disclosure may be widely applied in green technology fields such as electric vehicles, battery charging stations, and solar power generation and wind power generation using batteries. In addition, the battery cell and battery module of the present disclosure may be used in eco-friendly electric vehicles, hybrid vehicles, or the like, to prevent climate change by suppressing air pollution and greenhouse gas emissions.

According to an aspect of the present disclosure, a battery cell may include: a case accommodating an electrode assembly in an accommodating space; a cap plate coupled to at least one side of the case; a vent provided in the case or the cap plate; and a venting cover disposed to cover the vent, and provided to be opened by pressure acting from the accommodating space to the outside of the case, wherein the venting cover includes a venting sheet provided to be opened by a predetermined amount of pressure, and including a first surface facing the vent and a second surface opposite to the first surface; and a venting cap having a support portion supporting the first surface of the venting sheet.

In addition, according to an embodiment, the venting sheet may include a venting line formed on at least one of the first surface or the second surface.

In addition, according to an embodiment, the venting sheet may be disposed to face the vent in a first direction, and the support portion may be disposed to correspond to the venting line, so that at least a portion of the support portion may be provided to overlap the venting line in the first direction.

In addition, according to an embodiment, the venting line may be formed by being partially recessed from the second surface.

In addition, according to an embodiment, the vent may be provided to be opened by a predetermined amount of pressure and provided to connect the accommodating space and the exterior of the case for communication therebetween.

In addition, according to an embodiment, the vent may include a notch groove formed by being at least partially recessed in a thickness direction.

In addition, according to an embodiment, the venting cover may be provided to be opened when pressure within the accommodating space becomes greater than pressure outside the case by a predetermined range, to be opened by force toward the outside of the case from the accommodating space.

In addition, according to an embodiment, the venting cover further includes a venting space formed between the venting sheet and the vent, the vent may be provided to be opened by a pressure difference between the accommodating space and the venting space, and the venting sheet may be provided to be opened toward the outside of the case when the vent is opened.

In addition, according to an embodiment, the vent includes a notch recessed at least partially in the first direction.

In addition, according to an embodiment, the support portion is disposed between the venting sheet and the vent.

In addition, according to an embodiment, further comprising a terminal portion disposed on the cap plate and electrically connected with the electrode assembly, wherein the terminal portion includes: a cathode terminal electrically connected with a cathode tab of the electrode assembly; and an anode terminal electrically connected with an anode tab of the electrode assembly.

In addition, according to an embodiment, the venting cover is disposed between the cathode terminal and the anode terminal.

In addition, according to an embodiment, the vent is disposed between the cathode terminal and the anode terminal.

In addition, according to an embodiment the venting lines is plurality, and the plurality of venting lines are arranged in a second direction perpendicular to the first direction.

In addition, according to an embodiment, the support portion is provided in plurality, and the plurality of support portions are arranged in the second direction.

According to an aspect of the present disclosure, a battery cell may include: a case accommodating an electrode assembly in an accommodating space; a cap plate coupled to at least one side of the case; and a venting cover provided in the cap plate or the case, and provided to be opened in a direction toward the outside of the case from the accommodating space, wherein the venting cover includes: a venting sheet provided to be opened by a predetermined amount of pressure, and including a venting line formed on at least one of a first surface facing the accommodating space and a second surface opposite to the first surface, in a first direction; and a venting cap having a support portion supporting the first surface of the venting sheet, wherein at least a portion of the support portion is provided to overlap the venting line in the first direction.

According to an aspect of the present disclosure, a battery module may include: a plurality of battery cells; and a module housing accommodating the plurality of battery cells, wherein at least one of the plurality of battery cells includes a case accommodating an electrode assembly in an accommodating space; a cap plate coupled to at least one side of the case; a vent provided in the case or the cap plate; and a venting cover disposed to cover the vent, and provided to be opened by a pressure acting from the accommodating space to the exterior of the case, wherein the venting cover includes: a venting sheet provided to be opened by a predetermined amount of pressure, and including a first surface facing the vent and a second surface opposite to the first surface; and a venting cap having a support portion supporting the first surface of the venting sheet.

As described above, the solution according to the present disclosure has been described, but this is exemplary, and it should be understood that other configurations that are not mentioned are also included in the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a battery cell according to an embodiment of the present disclosure.

FIG. 2 is a schematic internal cross-sectional view taken along line I-I′ of FIG. 1.

FIG. 3 is an exploded view of a venting cap.

FIG. 4 is an enlarged view of A in FIG. 2.

FIG. 5 is a diagram exemplarily illustrating that a venting cover is opened to the outside of the case.

FIG. 6 is a diagram exemplarily illustrating that reverse inflow of gas flowing from the outside of the case is prevented.

FIG. 7 is a battery module according to an embodiment of the present disclosure.

FIG. 8 is a diagram exemplarily illustrating that an event has occurred in one battery cell of the battery module.

### DETAILED DESCRIPTION

Prior to the detailed description of the present disclosure, the terms or words used in the present specification and claims described below should not be construed as being limited to a common or dictionary meaning, and the inventor intends to use his/her invention in the best way. Based on the principle that terms may be properly defined for description, they should be interpreted as meanings and concepts consistent with the technical spirit of the present disclosure.

The same reference numbers or symbols described in each drawing represent parts or components that perform substantially the same functions. For convenience of description and understanding, the same reference numbers or symbols may be used in different embodiments.

In the following description, singular expressions include plural expressions unless the context clearly dictates otherwise. It should be understood that terms such as “include” or “comprise” are intended to specify the presence of a feature, number, step, operation, component, part, or combination thereof described in the specification, but do not exclude in advance the possibility of the presence or addition of one or more other features, numbers, steps, operations, components, parts, or combinations thereof.

In addition, in the following description, expressions such as upper side, upper portion, lower side, lower portion, side surface, front, rear, etc. are expressed based on the direction illustrated in the drawings, and may be expressed differently if the direction of the object is changed.

In addition, terms including ordinal numbers such as “first,” “second,” or the like. may be used to distinguish between components in the description and claims below. These ordinal numbers are used to distinguish between identical or similar components, and the meaning of the terms should not be limited due to the use of these ordinal numbers. For example, the components associated with these ordinal numbers should not be interpreted in a restricted order of use or disposition by their numbers. If necessary, respective ordinal numbers may be used interchangeably.

Hereinafter, the present disclosure will be described in detail with reference to the drawings.

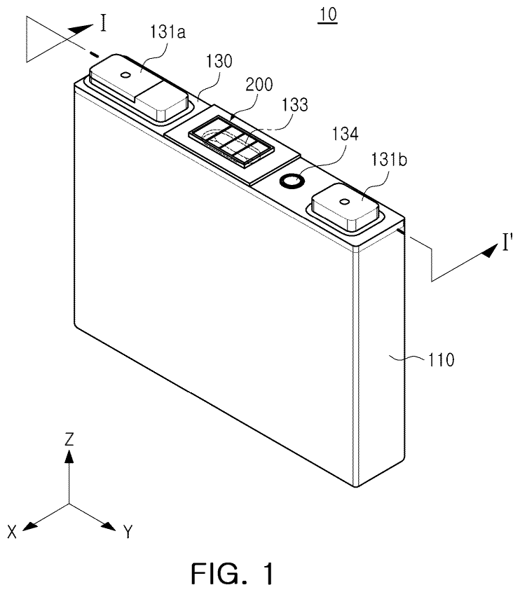

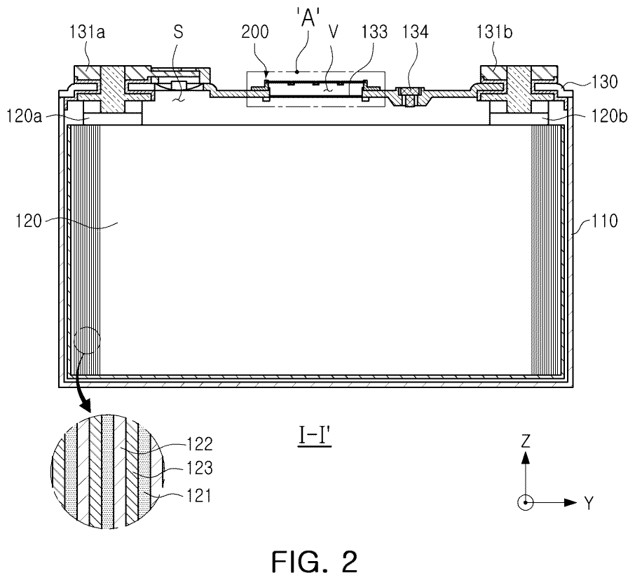

FIG. 1 is a perspective view of a battery cell according to an embodiment of the present disclosure, and FIG. 2 is a schematic internal cross-sectional view taken along line I-I′ of FIG. 1.

Referring to FIGS. 1 and 2, a battery cell 10 of the present disclosure may include a case 110 accommodating an electrode assembly 120 in an accommodating space S, a cap plate 130 coupled to at least one side of the case 110, a vent 133 provided in the case 110 or the cap plate 130, and a venting cover 200 disposed to cover the vent 133 but provided to be opened by pressure acting from the accommodating space S to the outside of the case 110. Here, the venting cover 200 may include a venting sheet 230 provided to be opened by a predetermined amount of pressure, and including a first surface facing the vent 133 and a second surface opposite to the first surface, and a venting cap 210 having a support portion supporting the first surface of the venting sheet 230.

The case 110 may provide an accommodating space S in which an electrode assembly 120 to be described later can be accommodated. In the drawing, the case 110 is expressed as a roughly rectangular shape, but this is only an example, and the case may be changed into various shapes as long as it has a structure in which an accommodating space S for receiving the electrode assembly 120 is formed.

In addition, a cap plate 130, to be described later, may be coupled to an opening (not shown) of the case 110 to seal the accommodating space S.

A material of the case 110 may be appropriately selected in consideration of thermal and electrical conductivity, rigidity corresponding to swelling of the electrode assembly 120, processability, manufacturing cost, or the like. For example, the case 110 may be formed of a metal material including aluminum, aluminum alloy, or the like.

The electrode assembly 120 may be disposed in the accommodating space S of the case 110. The electrode assembly 120 may include a cathode material 121. The cathode material 121 may include a cathode current collector and a cathode active material. In some embodiments, the cathode current collector may include aluminum, an aluminum alloy, or the like, and the cathode active material may include lithium cobalt oxide, lithium manganese oxide, lithium nickel oxide, lithium iron phosphate, or the like. The cathode active material may be coated on a surface of the cathode current collector. Portions of the cathode current collector, uncoated with the cathode active material, may function as cathode tabs 120a. In some embodiments, the cathode tab 120a may be provided in plural, and some or all of the plurality of cathode tabs 120a may be bonded to each other.

The electrode assembly 120 may include an anode material 122. The anode material 122 may include an anode current collector and an anode active material. In some embodiments, the anode current collector may include copper, a copper alloy, nickel, a nickel alloy, or the like, and the anode active material may include carbon, silicon, or the like. The anode active material may be coated on a surface of the anode current collector. Portions of the anode current collector, uncoated with an anode active material, may function as an anode electrode tab 120b. In some embodiments, the anode tab 120b may be provided in plural, and some or all of the plurality of anode tabs 120b may be bonded to each other.

The electrode assembly 120 may include a separator 123. The separator 123 may be disposed between a cathode material 121 and an anode material 122. The separator 123 may function to provide a passage for the movement of ions, while physically contacting the cathode material 121 and the anode material 122. For example, the separator 123 may include a porous polymer film or a porous substrate. In some embodiments, the separator 123 may be formed of a polymer material including polyethylene, polypropylene, or the like. In addition, the separator 123 may include a dry and wet separator. In some embodiments, the separator 123 may include a coating layer including a ceramic coating layer or the like.

The electrode assembly 120 may formed by disposing the above-described components in a method such as winding, stacking, or the like. For example, the electrode assembly 120 may be formed in a structure in which the cathode material 121, the anode material 122, and the separator 123 are wound around an axis in a longitudinal direction or transverse direction. Alternatively, the electrode assembly 120 may be formed as a structure in which the above-described winding structure is compressed in a direction approximately perpendicular to a winding axis. The above-described winding structure may be referred to as a ‘jelly roll’ in the art.

As another example, the electrode assembly 120 may be formed in a structure in which a cathode material 121, an anode material 122, and a separator 123 are sequentially stacked in a vertical direction (e.g., in a thickness direction or height direction of the electrode assembly). In some cases, the separator 123 in the stacked structure may be formed as a stacked structure in which a plurality of unit separators 123, continuous in the longitudinal direction, are sequentially folded according to the stack of the cathode material 121 and the anode material 122. The above-described stacked structure may be referred to in the art as ‘stack and folding,’ ‘z-folding,’ or the like. However, in this embodiment, the disposition of each component of the electrode assembly 120 is not particularly limited. The electrode assembly 120 may have various dispositions other than those exemplified above.

In some embodiments, the electrode assembly 120 may be formed by combining a plurality of unit units. For example, the electrode assembly 120 may include unit units wound in a jelly roll manner, and two or more of the unit units may be combined to form an electrode assembly 120. In the present embodiment, the electrode assembly 120 is comprised of two jelly roll units. As another example, the electrode assembly 120 may include a unit unit wound in a stack-and-fold manner, and two or more of the unit units may be combined to form an electrode assembly 120.

The electrode assembly 120 may be accommodated in an accommodating space S of the case 110 together with an electrolyte. In some embodiments, the electrolyte can be formed of an organic solvent containing a lithium salt. For example, the lithium salt may include lithium hexafluorophosphate (LiPF6), lithium tetrafluoroborate (LiBF4), or the like, in a liquid or gel state, and the organic solvent may include cyclic carbonates such as ethylene carbonate (EC), propylene carbonate (PC), or the like, and linear carbonates such as diethyl carbonate (DEC), dimethyl carbonate (DMC), ethyl methyl carbonate (EMC), or the like.

In some other embodiments, the electrolyte may be omitted or replaced. For example, when an inorganic solid electrolyte is used, the liquid or gel-type electrolyte may be omitted.

In addition, the structure of the electrode assembly 120 illustrated in the present disclosure is exemplary. In the present disclosure, an electrode assembly 120 including a cathode tab 120a and an anode tab 120b arranged in parallel from one side of the electrode assembly 120 is illustrated, but the positions and/or numbers of the cathode tab 120a and the anode tab 120b are exemplary. For example, in an embodiment not shown, the cathode tab 120a and the anode tab 120b may be disposed with the electrode assembly 120 (e.g., cathode material 121), anode material 122, and separator 123) interposed therebeteween. At least a portion of the cathode tab 120a and the anode tab 120b may be disposed between the case 110 and the electrode assembly 120. respectively.

The cap plate 130 may be coupled to the case 110 to close an opening of the case 110. In the drawing, the cap plate 130 is illustrated as a square plate shape corresponding to the opening of the case 110.

The cap plate 130 may be coupled to the case 110 to seal the accommodating space S of the case 110 in which the electrode assembly 120 is disposed. In some embodiments, the cap plate 130 may be welded to the case 110 by ultrasonic welding, laser welding, or the like. Terminal portions 131a and 131b electrically connected to the electrode assembly 120 may be disposed on the cap plate 130. The battery cell 10 may be electrically connected to an external power source through the terminal portions 131a and 131b. The terminal portions 131a and 131b may include a cathode terminal 131a and an anode terminal 131b. The cathode terminal 131a may be electrically connected to the cathode tab 120a of the electrode assembly 120, and the anode terminal 131b may be electrically connected to the anode tab 120b of the electrode assembly 120.

The cap plate 130 may include a vent 133. In the present disclosure, it is illustrated that the vent 133 is disposed between the cathode terminal 131a and the anode terminal 131b, but the position of the vent 133 may be variously changed as needed and is not necessarily limited to what is exemplified. For example, in another embodiment not shown, a vent 133 be disposed or added to the case 110.

The vent 133 may be formed to be opened in response to internal pressure of the case 110. In other words, the vent 133 may be provided to be opened by a predetermined amount of pressure, thereby allowing the accommodating space(s) and the outside of the case 110 to be in communication. Thereby, the vent 133 can function to discharge the internal pressure to the outside of the case 110 and contribute to stabilizing internal elements of the case 110.

According to an embodiment of the present disclosure, the vent 133 may include a notch 133a of a predetermined shape. The notch 133a may be a vulnerable portion formed to be at least partially recessed in the thickness direction of the vent 133. Since a fracture of the vent 133 is induced through the notch by the difference between pressure within the accommodating space(S) or pressure outside the case 110, the accommodating space(S) of the case 110 may be in communication with the outside of the case.

Meanwhile, in the present disclosure, a secondary battery 100 including a case 110 including one opening and a cap plate 130 disposed on one side of the case 110 is illustrated, but this is exemplary. In an embodiment not illustrated, a secondary battery 100 including a plurality of cap plates 130 disposed on both sides of the case 110 may be provided. For example, the secondary battery 100 may include a first cap plate disposed on one side of the case 110 and a second cap plate disposed on the other side of the case 110.

In addition, the present disclosure may include a liquid injection unit 134 that allows fluid to flow by connecting the accommodating space(S) of the case 110 and the exterior of the case 110 for communication therebetween. The liquid injection unit 134 may be provided so that a fluid, such as an electrolyte, flowing into the accommodating space(S) can flow. The liquid injection unit 134 may include an injection hole (not shown) formed in the cap plate 130 and an injection cap (not shown) sealing the injection hole. The fluid may be injected into the accommodating space(S) through the injection hole and then the injection hole may be closed with the injection cap.

Hereinafter, a venting cover 200 of the present disclosure will be described in detail with reference to the drawings.

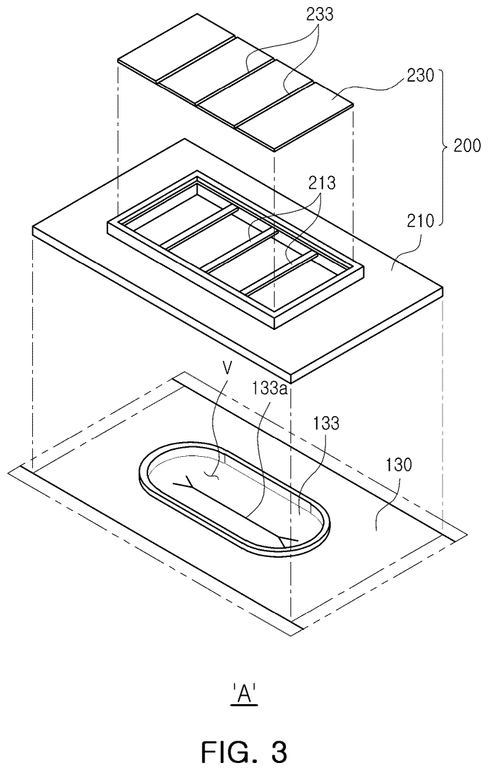

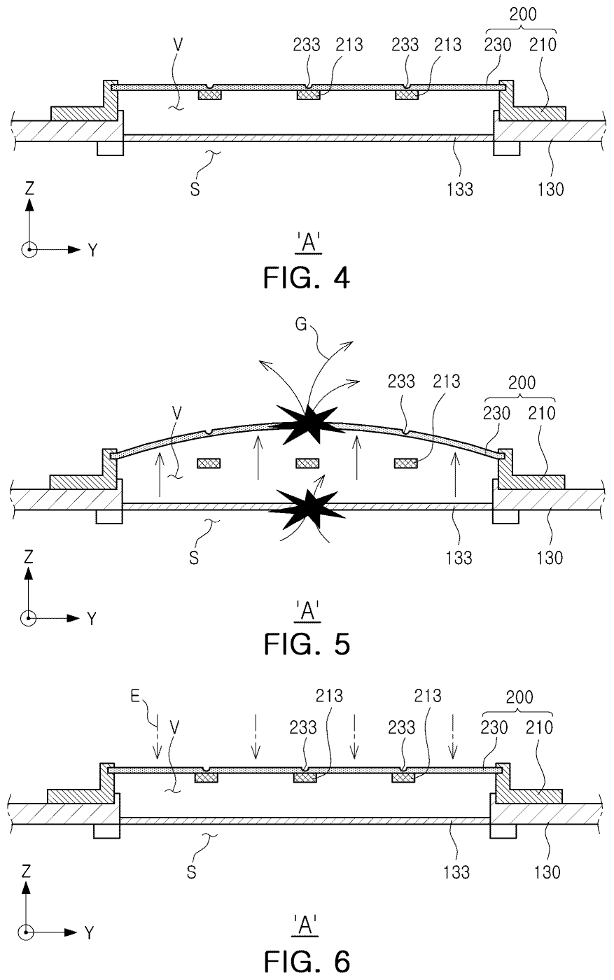

FIG. 3 is an exploded view of a venting cap, and FIG. 4 is an enlarged view of A in FIG. 2.

Referring to FIGS. 3 and 4 together, the venting cover 200 may include a venting cap 210 including a support portion 213 and a venting sheet 230 mounted on the support portion 213 of the venting cap 210 and covering the vent 133.

The venting cap 210 can support the venting sheet 230. The venting cap 210 may be disposed on a location in which the vent 133 is provided among the cap plate 130 and the case 110 and support the venting sheet 230. The venting cap 210 may have a hole formed, in communication with the vent 133 therein and include a support portion 213 crossing the hole. The venting cap 210 may support the venting sheet 230 through the support portion 213.

The support portion 213 may be disposed to be spaced apart from the vent 133 by a predetermined distance in a first direction (Z-axis direction). Thereby, the venting cover 200 may further include a venting space (V) between the vent 133 and the venting sheet 230 thereinside.

The venting sheet 230 may be installed in the support portion 213 to block the hole of the venting cap 210. The venting sheet 230 may include a first surface (lower surface) facing the vent 133 and a second surface (upper surface) opposite thereto.

The venting sheet 230 may have a venting line 233, at least partially recessed in a thickness direction, formed therein. The venting line 233 may be formed on at least one of the first surface (lower surface) and the second surface (upper surface). That is, the venting line 233 may be a vulnerable portion provided to be the first to be fractured in the venting sheet 230.

The support portion 213 of the venting cap 210 may be provided to support the venting line 233. In other words, the support portion 213 may be provided so that at least a portion thereof overlaps the venting line 233 in the first direction (Z-axis direction), to correspond to the venting line 233. That is, the support portion 213 may be provided to support a vulnerable portion of the venting sheet 230.

Meanwhile, the venting line 233 may be formed by being recessed from the second surface (upper surface) of the venting sheet 230. Thereby, a contact area between the venting sheet 230 and the support portion 213 may be increased. However, as described above, this is merely an example of the present disclosure. For example, the venting line 233 may be provided by being recessed from the first surface (lower surface) of the venting sheet 230. As another example, the venting line 233 may be formed on both the first surface (lower surface) and the second surface (upper surface) of the venting sheet 230.

Meanwhile, according to another embodiment of the present disclosure, only a venting cover 200 may be provided without a vent 133. According to another embodiment of the present disclosure, a case 110 accommodating the electrode assembly 120, a cap plate 130 coupled to at least one side of the case 110, and a venting cover 200 provided in the cap plate 130 or the case 110, and provided to be opened in a direction toward the outside of the case 110 from the accommodating space S may be included. Here, the venting cover 200 may include a venting sheet 230 provided to be opened by a predetermined amount of pressure and including a venting line 233 formed on at least one of a first surface (lower surface) facing the accommodating space S in the first direction (Z-axis direction) or a second surface (upper surface) opposite to the first surface; and a venting cap 210 having a support portion 213 supporting the first surface (lower surface) of the venting sheet 230. In this case, the support portion 213 may be provided so that a portion thereof overlaps the venting line 233 in the first direction (Z-axis direction), so that the venting sheet 230 is not fractured even when force is applied downwardly (−Z-axis direction). In the other embodiment, the configuration of the venting cover 200 overlaps with those described above, and is therefore omitted.

Meanwhile, in the present disclosure, a space inside the case 110 may be defined as an accommodating space S, a space between the vent 133 and the venting sheet 230 may be defined as a venting space V, and the outside of the case 110 may be referred to as an external space.

The vent 133 may be provided to be fractured and opened by pressure between the accommodating space S and the venting space V. The venting sheet 230 may be provided to be fractured by pressure between the venting space V and the external space.

In other words, the pressure generated within the accommodating space S is first applied to the vent 133, and conversely, the pressure generated outside the case 110 may be first applied to the venting sheet 230. Here, if the venting sheet 230 is not fractured by the pressure from gas, or the like, generated outside the case 110, the vent 133 may not be opened. According to an embodiment of the present disclosure, the venting sheet 230 is provided to not be opened by the pressure generated outside the case 110, thereby preventing gas, flames, or the like, flowing from the outside of the case from flowing into the interior of (accommodating space: S) the case 110. That is, according to the present disclosure, the venting cover 200 may be selectively opened depending on the direction of the force applied to the venting cover 200.

Hereinafter, a structure of a venting cover which is selectively opened depending on a direction in which pressure is applied is described with reference to the drawings.

FIG. 5 is a diagram exemplarily illustrating that a venting cover is opened to the outside of a case, and FIG. 6 is a diagram exemplarily illustrating that a reverse inflow of gas or the like flowing from the outside of the case is prevented.

Referring to FIG. 5, flames or gas (G) generated within an accommodating space S and discharged to the outside thereof ruptures the vent 133 and enters a venting space V, and then pressurizes the venting sheet 230 to bend upwardly (in a +Z-axis direction), thereby rupturing the venting sheet 230. In this case, the venting sheet 230 may be fractured along a venting line 233. Thereby, flames or gas (G) generated within the accommodating space (S) may be discharged the outside of the battery cell 10.

As described above, the venting cover 200 may be provided to be opened when the pressure in the accommodating space (S) becomes greater than the pressure outside the case 110 by a predetermined range, to be opened by force toward the outside of the case 110 in the accommodating space.

In addition, in an embodiment of the present disclosure, the vent 133 may be provided to be opened by a pressure difference between the accommodating space (S) and the venting space (V), and the venting sheet 230 may be provided to be opened toward the outside of the case 110 when the vent 133 is opened.

On the other hand, referring to FIG. 6, flames or gas (E) flowing outside the battery cell 10 presses the venting sheet 230 downwardly (in a −Z axis direction) from the outside of the venting sheet 230. In this case, the venting sheet 230 is supported by the support portion 213, so the venting sheet 230 may not be bent in a pressing direction. In particular, since the support portion 213 supports a lower surface of a portion in which the venting line 233, which is a vulnerable portion of the venting sheet 230, is formed, the venting line 233 may be prevented from being fractured by external flames or gas (E). This can prevent the external flames or gas (E) from rupturing the vent 133 and flowing into the accommodating space (S). In addition, particles such as conductive particles included in the external flames or gas (E) may be prevented from flowing back into the accommodating space (S).

As described above, the battery cell 10 of the present disclosure may allow flames or gas (G) generated within the accommodating space (S) to flow toward the exterior, but prevent or minimize flames or gas (E) generated from the outside thereof from flowing into the accommodating space (S).

That is, whether the venting cover 200 is opened may be determined depending on the pressing direction (force) applied to the venting cover 200.

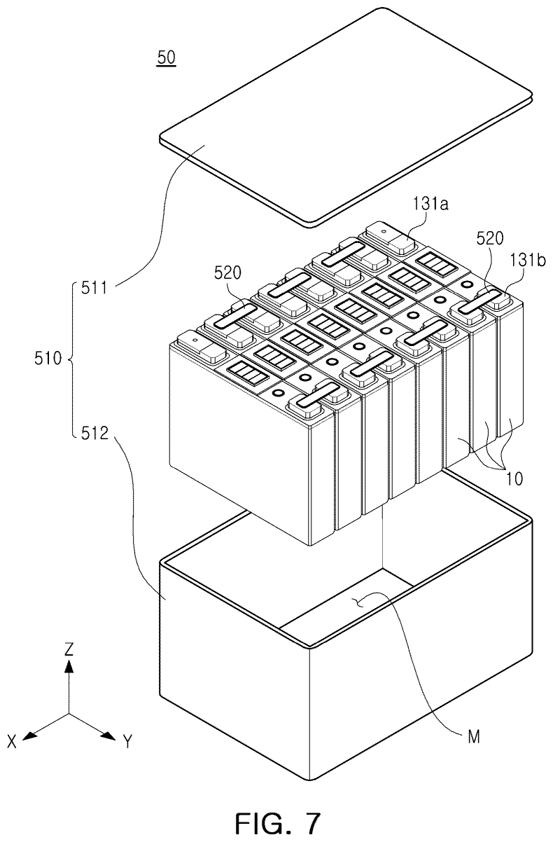

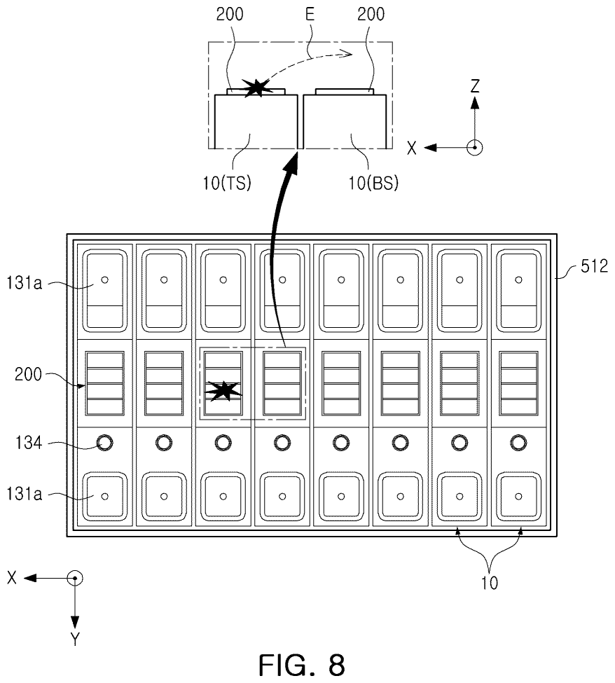

FIG. 7 is a diagram illustrating a battery module according to an embodiment of the present disclosure, and FIG. 8 is a diagram exemplarily illustrating that an event has occurred in one battery cell in a battery module.

Referring to FIG. 7, a battery module 50 according to an embodiment of the present disclosure may accommodate a plurality of battery cells 10. Here, the plurality of battery cells 10 may include at least one battery cell 10 of the present disclosure described above in FIGS. 1 to 6.

In other words, the battery module 50 according to an embodiment of the present disclosure may include a plurality of battery cells 10 and a module housing 510 accommodating the plurality of battery cells 10. Here, at least one of the plurality of battery cells 10 may include a case 110 accommodating an electrode assembly 120 in an accommodating space S, a cap plate 130 coupled to at least one side of the case, a vent 133 provided in the case 110 or the cap plate 130, and a venting cover 200 disposed to be opened by pressure acting from the accommodating space S to the exterior of the case. Here, the venting cover 200 may include a venting sheet 230 provided to be opened by a predetermined amount of pressure, and including a first surface facing the vent 133 and a second surface opposite to the first surface, and a venting cap 210 having a support portion 213 supporting the first surface of the venting sheet 230.

The housing 510 may include a lower cover 512 having an internal space (M) formed therein and an upper cover 511 coupled to the lower cover 512 to close the internal space (M).

In addition, the battery module 50 of the present disclosure may include a plurality of bus bars 520 electrically connecting the plurality of battery cells 10 to each other. The bus bar 520 may be formed of an electrically conductive material such as metal and may electrically connect terminals 131a and 131b of adjacent battery cells 10 to each other. In an embodiment not shown, the housing 510 may further include a module terminal electrically connected to an external power source, and the module terminal may be electrically connected to the bus bar 520.

Referring to FIG. 8, if an event such as thermal runaway occurs in one (TS) of the plurality of battery cells 10, flames or gas (E) generated within the battery cell 10 may be ejected into the internal space (M). The flames or gas (E) may increase the pressure within the internal space (M) and flow toward an adjacent battery cell (BS), and as described above, the venting cover 200 of the adjacent battery cell (BS) may prevent the flames or gas (E) from flowing into the accommodating space S. Thereby, the battery module 50 of the present disclosure may delay as much as possible the occurrence of thermal runaway in one battery cell 10, which can cause a short circuit in the adjacent battery cell 10.

As set forth above, according to an embodiment of the present disclosure, a battery cell may discharge flames, gas, or the like, within an accommodating space to the outside of a case when an event has occurred, but may prevent flames, gases, or the like, from the outside of the case, from flowing into the accommodating space.

According to an embodiment of the present disclosure, a battery module may discharge flames, gas, or the like, within an accommodating space to the outside of a case, when an event has occurred, but may prevent flames, gas, or the like, generated within an adjacent a battery cell from flowing into the battery module.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

The above-described description is merely an example of applying the principles of the present disclosure, and other configurations may be further included without departing from the scope of the present disclosure.

What is claimed is:

1. A battery cell, comprising:
a case accommodating an electrode assembly in an accommodating space;
a cap plate coupled to at least one side of the case;
a vent provided in the case or the cap plate; and
a venting cover disposed to cover the vent, and provided to be opened by pressure acting from the accommodating space to the outside of the case,
wherein the venting cover includes
a venting sheet provided to be opened by a predetermined amount of pressure, and including a first surface facing the vent and a second surface opposite to the first surface; and
a venting cap having a support portion supporting the first surface of the venting sheet.

2. The battery cell of claim 1, wherein the venting sheet includes a venting line formed on at least one of the first surface or the second surface.

3. The battery cell of claim 2, wherein the venting sheet is disposed to face the vent in a first direction, and
the support portion is disposed to correspond to the venting line, and at least a portion of the support portion overlaps the venting line in the first direction.

4. The battery cell of claim 2, wherein the venting line is formed by being partially recessed from the second surface.

5. The battery cell of claim 1, wherein the vent is provided to be opened by a predetermined amount of pressure and to communicate the accommodating space and the outside of the case.

6. The battery cell of claim 5, wherein the vent includes a notch groove formed by being at least partially recessed in a thickness direction.

7. The battery cell of claim 1, wherein the venting cover is provided to be opened when pressure within the accommodating space becomes greater than pressure outside the case by a predetermined value, to be opened by force toward the outside of the case from the accommodating space.

8. The battery cell of claim 1, wherein the venting cover further comprises a venting space formed between the venting sheet and the vent,
the vent is provided to be opened by a pressure difference between the accommodating space and the venting space, and
the venting sheet is provided to be opened toward the outside of the case when the vent is opened.

9. The battery cell of claim 1, wherein the vent includes a notch recessed at least partially in the first direction.

10. The battery cell of claim 1, wherein the support portion is disposed between the venting sheet and the vent.

11. The battery cell of claim 1, further comprising a terminal portion disposed on the cap plate and electrically connected with the electrode assembly,
wherein the terminal portion includes:
a cathode terminal electrically connected with a cathode tab of the electrode assembly; and
an anode terminal electrically connected with an anode tab of the electrode assembly.

12. The battery cell of claim 11, wherein the venting cover is disposed between the cathode terminal and the anode terminal.

13. The battery cell of 12, wherein the vent is disposed between the cathode terminal and the anode terminal.

14. The battery cell of claim 1, wherein the venting lines is plurality, and the plurality of venting lines are arranged in a second direction perpendicular to the first direction.

15. The battery cell of claim 1, wherein the support portion is provided in plurality, and the plurality of support portions are arranged in the second direction.

16. A battery cell, comprising:
a case accommodating an electrode assembly in an accommodating space;
a cap plate coupled to at least one side of the case; and
a venting cover provided in the cap plate or the case, and provided to be opened from the accommodating space in a direction toward the outside of the case,
wherein the venting cover includes:
a venting sheet provided to be opened by a predetermined amount of pressure, and including a venting line formed on at least one of a first surface facing the accommodating space and a second surface opposite to the first surface in a first direction; and
a venting cap having a support portion supporting the first surface of the venting sheet,
wherein at least a portion of the support portion is disposed to overlap the venting line in the first direction.

17. A battery module, comprising:
a plurality of battery cells; and
a module housing accommodating the plurality of battery cells,
wherein at least one of the plurality of battery cells includes
a case accommodating an electrode assembly in an accommodating space;
a cap plate coupled to at least one side of the case;
a vent provided in the case or the cap plate; and
a venting cover disposed to cover the vent, and provided to be opened by pressure acting from the accommodating space to the outside of the case,
wherein the venting cover includes:
a venting sheet provided to be opened by a predetermined amount of pressure, and including a first surface facing the vent and a second surface opposite to the first surface; and
a venting cap having a support portion supporting the first surface of the venting sheet.
